(19) United States
(12) Patent Application Publication
(10) Pub. No.: US 2025/0276887 A1
(43) Pub. Date: Sep. 4, 2025

(54) Beverage Concentrate Cartridge with Integrated Filter

(71) Applicant: Heineken Supply Chain B.V., Amsterdam (NL)

(72) Inventors: Eric Richard Brouwer, Amsterdam (NL); Bart Jan Bax, Amsterdam (NL); Jeroen Frank Otto, Amsterdam (NL); Arie Maarten Paauwe, Amsterdam (NL)

(21) Appl. No.: 18/857,284

(22) PCT Filed: Apr. 19, 2023
(86) PCT No.: PCT/NL2023/050203

§ 371 Date: Oct. 16, 2024

(30) Foreign Application Priority Data
Apr. 19, 2022 (EP) 22168859.1

(51) Int. Cl. B67D 1/00; B67D 1/04; B67D 1/08

(52) U.S. Cl. CPC B67D 1/0078; B67D 1/0022; B67D 1/0462; B67D 1/0801; B67D 2001/0812; B67D 2210/0001

(57) ABSTRACT

A cartridge for holding a beverage concentrate is provided. The cartridge is arranged for use in a beverage dispenser for dispensing a post-mixed beverage from a beverage concentrate and a base liquid. The cartridge comprises an internal volume for holding the beverage concentrate, and a filter, wherein the filter is designed for filtering suspended particles from beverage concentrate passing from the internal volume through the filter. Suspended particles may in particular be present in beverage concentrate based on a fermented beverage.

### TECHNICAL FIELD

The aspects and embodiments thereof relate to the field of forming and dispensing a post-mixed beverage formed by mixing a beverage concentrate with a base liquid.

### BACKGROUND

Beverages, such as soft drinks, beers, and cocktails can be consumed at locations different from the location where they are produced. As such, the beverages have to be transported. In order to reduce the mass and volume to be transported, it has been suggested to concentrate the beverage—i.e. reduce the water content—prior to transport. The beverage concentrate may be mixed with a base liquid to obtain a post-mixed beverage, with a concentration, consistency and flavour approximating the concentration, consistency and flavour of the original beverage.

A cartridge, otherwise referred to as container, pod, or capsule, may be used as a vessel for holding the concentrate beverage. A user may provide the cartridge to a beverage dispenser, in which the concentrate may be mixed with a base liquid such as water.

### SUMMARY

It has been observed that when the beverage concentrate comprises particles, in particular dispersed, suspended or settled particles, the post-mixed beverage may appear hazy—i.e. has a high turbidity and/or appears turbid. This turbidity may be higher than the beverage on which the beverage concentrated is based, and may be undesired for aesthetic reasons and/or other reasons. It has further been observed that the concentration of particles in the beverage concentrate may increase over time, especially when the beverage concentrate is based on a fermented beverage, in particular beer, more in particular a beer based on cereal grain such as barley.

A general aim is to reduce turbidity of a post-mixed beverage formed by mixing one or more beverage concentrates with one or more base liquids. Preferably, the turbidity is reduced such that the turbidity of the post-mixed beverage corresponds or approximately corresponds to the turbidity of a beverage on which the beverage concentrate has been based. Alternatively or additionally, a general aim is to reduce the amount of particles in a post-mixed beverage formed by mixing one or more beverage concentrates with one or more base liquids, for example to improve taste, perceived quality, and/or appearance of the post-mixed beverage.

A first aspect provides a cartridge for holding a beverage concentrate, the cartridge comprising an internal volume for holding the beverage concentrate, and a filter, wherein the filter is designed for filtering particles from a flow of liquid, such a beverage concentrate or post-mixed beverage, passing from the internal volume through the filter. This allows at least part of the particles present in the internal volume to be caught by the filter, resulting in a beverage concentrate or post-mixed beverage with a lower turbidity. The lower turbidity of the beverage concentrate may in turn result in a preferred lower turbidity of the post-mixed beverage.

It will be understood that the flow of liquid passing through the filter may be a mixture, suspension, or dispersion of small particles in a liquid. After having passed through the filter, the flow of liquid comprises less small particles, or even is essentially free of small particles. Small particles for example have a general particle size which is larger than 0.2 μm, larger than 1 μm, in particular between 0.2-100 μm or even between 0.1-50 μm.

The internal volume may be defined by a cartridge housing comprised by the cartridge. The cartridge housing may be substantially liquid-tight, apart from one or more fluid passages through the cartridge housing. A fluid passage may for example be embodied as a single through-hole through the cartridge housing, or as a plurality of through-holes through the cartridge housing. In use, the one or more through-holes may be formed by puncturing the cartridge housing, for example by one or more piercing members of a beverage dispenser.

The beverage concentrate may be based on a fermented beverage, such as a beer, wine or a cider. The beverage concentrate may as such comprise a liquid such as water with particles mixed, suspended and/or dispersed therein. The beverage concentrate may hence be an aqueous liquid. Over time, and for example dependent on a viscosity of the beverage concentrate, particles may settle in the liquid. However, when the cartridge is moved, for example by a user positioning the cartridge in a receptacle of a beverage dispenser, settled particles may resuspend in the liquid beverage concentrate.

The particles may be or comprise one or more proteins (proteinaceous material), sugars, organic compounds such as polyphenols, hop acids, and/or oxalates. As options, the beverage concentrate may be essentially free of ethanol or comprise a particular concentration of ethanol, such as 25% or less, 10% or less, 5% or less, or even 1% or less by volume. As a further option, the beverage concentrate may comprise dissolved carbon dioxide and/or any other gas such as nitrogen.

In examples, the beverage concentrate may comprise or consist of solid particles. As such, the beverage concentrate may for example be a powder or a tablet. The solid beverage concentrate can be dissolved, suspended, or dispersed into one or more base liquids. Multiple beverage concentrates may be used to form the post-mixed beverage, which multiple beverage concentrates may be in liquid and/or solid form. The one or more base liquids may for example be water, carbonated water, ethanol, ethanol dissolved in water, and/or any combination thereof. In particular when one or more base liquids are mixed with the beverage concentrate inside the cartridge, the beverage concentrate may comprise or consist of solid particles which can be dissolved into the one or more base liquids.

A beverage concentrate based on a fermented beverage may be obtained by concentrating a fermented beverage, and/or by brewing a fermented beverage with a high concentration of flavouring agents. The high concentration of flavouring agents may be higher than a typical concentration of flavouring agents for said fermented beverage. For example, when the beverage concentrate comprises four times the flavouring agents per volume compared to a conventional beverage, the concentrate has to be diluted four times to obtain the desired concentration of flavouring agents.

The high concentration of flavouring agents may result in a high dry matter content in the beverage concentrate, which is higher than a typical dry matter content in a conventional beverage. The high concentration of flavouring agents may be obtained by brewing the fermented beverage with a higher concentration of raw materials such as cereal grains, for example malted barley, wheat, or maize, and/or hops compared to the concentration of raw materials used for brewing a conventional beverage which is typically not mixed with a base liquid before consumption.

The beverage concentrate may in general comprise one or more flavouring agents, for example aimed to mimic the flavour of another beverage. In particular, flavouring agents may be used to mimic the flavour of a fermented beverage, such as a beer, wine, or a cider. A flavouring agent may for example be an aromatic compound, an ester or an alcohol. By mixing one or more flavouring agents, in particular into an aqueous solution, a beverage concentrate may hence be obtained. It will thus be understood that a beverage concentrate may also be formed without a brewing or fermenting process.

For hygienic purpose, it may be an aim to provide for a beverage dispenser which allows for convenient discarding of filtered particles. As such, when the filter is comprised by the cartridge, when discarding the cartridge after use, the filtered particles are discarded as well and are not left behind in the beverage dispenser. It will be understood that the cartridge may be a single-serving disposable cartridge. Single-serving implies that a single quantity of post-mixed beverage can be dispensed using the cartridge, preferably in one continuous dispensing action. The single quantity may correspond to amount of beverage concentrate required to obtain a typical filling volume of a beverage container such as a glass, which quantity may for example be 200 mL, 250 mL, 300 mL, 500 mL, or 568 mL (i.e. 1 pint), when the beverage concentrate is mixed with a volume of base liquid.

The cartridge may further be a single-use cartridge, i.e. not arranged to be refilled with beverage concentrate after being used to dispense beverage concentrate from the cartridge. Preferably, the cartridge comprises recyclable materials.

Alternatively, the cartridge may be a multiple serving disposable cartridge. From a multiple serving disposable cartridge, a plurality of discrete volumes of beverage concentrate can be dispensed.

The filter may restrict or fully block passage of the beverage concentrate, if the pressure difference between the beverage concentrate in the internal volume and the outside of the filter is insufficient to push or suck the beverage concentrate through the filter. In embodiments, the pressure of the fluid column of beverage concentrate may be insufficient to push the beverage concentrate through the filter. As such, an external pressure may be required to push the beverage concentrate from the internal volume of the cartridge through the filter. The external pressure may be provided by an expelling actuator comprised by a beverage dispenser, or may be provided by the ambient pressure when a pressure downstream of the filter is lowered to a pressure below ambient pressure by an expelling actuator, or may be provided by a combination of the two.

To prevent undesired leakage of beverage concentrate out of the cartridge, for hygienic reasons, and/or to protect the filter from outside influences such as impacts and/or contaminants, embodiments of the cartridge further comprise a seal. The filter may be positioned between the seal and the internal volume of the cartridge. Between the filter and the seal, air or another gas may be present. It may be preferred to fill the volume between the seal and the filter with a gas which has a low oxygen content such as dinitrogen or CO2 gas, or a mixture thereof, in particular in case the filter is permeable to oxygen. This in turn may increase the shelf-life of the cartridge.

The seal may be a removable seal, which may be removable by a user or by a beverage dispenser. For example, the seal may be attached to the cartridge using glue or welding. As another example, the seal may be connected to the cartridge via a weakened section. The seal may be removed from the cartridge by ripping or otherwise breaking the weakened section.

In other embodiments, the seal may be arranged to at least partially dissolve or decompose, for example when exposed to a base liquid. When the seal is decomposed into smaller particles, these particles may be caught in a filter.

A distance between the seal and the filter may allow for a piercing element of a beverage dispenser to pierce the seal, without piercing the filter. If the filter would be pierced, capturing particles from the beverage concentrate using the filter may become less effective.

Many different types of filters are envisioned. The filter may for example be a semi-permeable filter, such as a paper filter. In general, a semi-permeable filter may allow passage of a liquid, while blocking passage of solids by catching solids in the filter. Depending on the size of the solids, the solids may be caught in the filter, or when the solids are small enough, solids may pass through the filter. In particular when some solids are preferred to be present in the post-mixed beverage, the filter may be tuned to allow passage of these preferred solids, for example based on typical sizes of the preferred solids.

The filter may have an open-cell structure. For example, the filter may be a sintered filter, formed by sintering of a material such as a copper, stainless steel, any other metal, or a polymer. By virtue of the sintering process, an open-cell structure may be obtained for the filter. By virtue of the cell size of the open-cell structure, solid particles may become trapped while liquid is able to pass through the filter.

The filter may be embodied as a sieve with one or more pores. The pores may have a particular flow-through area or pore size, arranged to catch particles in the beverage concentrate, while allowing the liquid part to flow through the filter.

In embodiment, the pore size of the filter may be between 0.2-100 μm (micrometre). More in particular, the pore size of the filter may be between 0.3-50 μm, or even between 0.4-25 μm.

The filter may be formed as a sandwich construction, wherein a filter material is sandwiched between two sandwich plates. The filter material is arranged to catch suspended particles from a flow of beverage concentrate flowing through the filter. The filter material may for example have a granular form, such as diatomite, or kieselguhr, or may be a porous material such as porous ceramic or porous metal. The sandwich plates are arranged to hold the filter material in place between the sandwich plates. A flow of fluid is allowed through the sandwich plates, for example through openings or other passages through the sandwich plates. The openings or other passages are typically not arranged to catch particles form a flow of beverage concentrate passing through the sandwich plates.

In general, a combination of different filters may be used in a single cartridge. Beverage concentrate may hence flow through one or more filters prior to being dispensed as the post-mixed beverage together with the base liquid. In particular, the beverage concentrate may flow through one or more filters prior to being mixed with the base liquid. Different filters may be designed for catching different types of particles, which particles may have a different composition and/or size.

The base liquid, or conceivably base liquids, with which the beverage concentrate is mixed to form the post-mixed beverage may comprise water, carbonated water and/or ethanol. In embodiments, the base liquid may be a beverage, such as a beer, cider, wine, or any other fermented beverage. The beverage concentrate may be used to add additional flavours to the base liquid.

As an option, the cartridge may comprise a temporary separator, which separator prevents contact between the filter and the beverage concentrate inside the internal volume. The separator is temporary in the sense that the separator is removed or opened up prior to expelling the beverage concentrate from the cartridge, for example by virtue of the beverage concentrate being forced through the separator.

During transport and storage of the cartridge, prior to the use of the cartridge, the separate prevents or reduces contact between the filter and the beverage concentrate. As such, the filter may remain dry during the shelf-life of the cartridge. The separator may as such be essentially impermeable to liquids, such as the liquid beverage concentrate.

In examples, the separator may be arranged to break when sufficient pressure is applied to the beverage concentrate inside the internal volume. The separator may alternatively be removable, for example by a user of by a beverage dispenser.

In embodiments, the cartridge may further comprise a spout, protruding away from the internal volume. In use, beverage concentrate may be expelled from the internal volume through the spout. The spout may be used to guide the beverage concentrate to a particular component of the beverage dispenser, or into a glass of a consumer. The filter may be positioned inside the spout, upstream of the spout, or downstream of the spout.

A second aspect provides a beverage dispenser assembly for dispensing a post-mixed beverage from a beverage concentrate and a base liquid. The beverage dispenser assembly comprises an embodiment of a beverage dispenser, and an embodiment of a cartridge, in particular a cartridge according to the first aspect.

The beverage dispenser comprises a dispenser housing with a receptacle for receiving at least part of the cartridge, a base liquid input for receiving a base liquid, a beverage concentrate input which is in fluid communication with the receptacle, a post-mixed beverage conduit which is in fluid communication with the base liquid input and the beverage concentrate input, and has a post-mixed beverage output at a downstream end, and an expelling actuator for expelling beverage concentrate from an internal volume of the cartridge, in particular through the filter of the cartridge.

As an alternative to expelling beverage concentrate through the filter of the cartridge using the expelling actuator, the filter may be moved through the beverage concentrate. Particles in the beverage concentrate may thus be caught in the filter. The beverage concentrate through which the filter has passed may be expelled from the cartridge and mixed to form the post-mixed beverage.

Due to the beverage concentrate having to pass through the filter of the cartridge, an increased expelling force may be required compared to a cartridge without a filter. The expelling force is applied by the expelling actuator of the beverage dispenser. In general, the expelling force may be used to push beverage concentrate out of the internal volume through the filter, or to suck beverage concentrate out of the internal volume through the filter.

It will thus be understood that in different embodiments, beverage concentrate may be sucked, pushed, pressed, and/or centrifuged through the filter. In general, this may be referred to as the beverage concentrate being expelled from the cartridge. For example, a venturi may be used for sucking a liquid such as a beverage concentrate out of the cartridge.

When the cartridge comprises a seal, the seal may be removed by the user, removed by the beverage dispenser, and/or pierced by a piercing member comprised by the beverage dispenser. The piercing member may thus be arranged to pierce the seal of the cartridge without piercing the filter.

As a particular option, the cartridge may be an expandable cartridge. In such cases, the cartridge housing is an expandable housing, arranged to be further filled with a base liquid, such that a post-mixed beverage can be formed inside the internal volume from the beverage concentrate and the base liquid.

A third aspect provides a method of dispensing a post-mixed beverage from a beverage concentrate and a base liquid. The method comprises steps of providing or receiving a cartridge with an internal volume holding a beverage concentrate, providing or receiving a base liquid, expelling the beverage concentrate from the cartridge, allowing the beverage concentrate and the base liquid to mix and form the post-mixed beverage and dispensing the post-mixed beverage. The beverage concentrate passes through a filter prior to the dispensing of the post-mixed beverage.

By virtue of the step of passing the beverage concentrate through a filter, particles suspended in the beverage concentrate may be caught before the post-mixed beverage is dispensed.

The filter may be comprised by the cartridge. When the filter is comprised by the cartridge, the filter may be disposed of together with the cartridge. As such, it may be assured that an unused filter is used for each cartridge.

Alternatively, the filter may be comprised by the beverage dispenser assembly, in particular by the beverage dispenser. A filter comprised by the beverage dispenser assembly may be suitable for catching particles from beverage concentrate supplied in multiple cartridges. The filter comprised by the beverage dispenser assembly may be supplied separate from the beverage dispenser, for example as an exchangeable filter cartridge. The filter may be positioned downstream of the cartridge, for example in a beverage concentrate conduit.

As a particular option, the beverage concentrate passes through the filter prior to the forming of the post-mixed beverage. As such, it may be prevented that the base liquid has to pass through the filter, and hence a smaller volume of liquid may have to pass through the filter. By passing the beverage concentrate through the filter prior to the forming of the post-mixed beverage, excessive foaming may be avoided, or foaming may be essentially fully avoided.

As another option, the beverage concentrate passes through the filter after having mixed into the post-mixed beverage. This may allow an alternative positioning of the filter, and also allows filtering of the base liquid. When the cartridge comprises the filter, the cartridge with particles trapped in the filter after the post-mixed beverage is dispensed may be discarded. As such, the particles may be discarded conveniently by the user. When the filter is provided separately from the cartridge, the filter may be single-serving, suitable for use with a plurality of cartridges, generally discardable or the filter may be cleanable and used again after cleaning.

### BRIEF DESCRIPTION OF THE FIGURES

FIGS. 1A-1D depict different embodiments of a cartridge for holding a beverage concentrate;

FIG. 2A depicts an even further embodiments of the cartridge for holding a beverage concentrate;

FIG. 2B depicts an example of an emptied cartridge;

FIGS. 2C and 2D depict and embodiment of a cartridge with a seal, which seal is respectively unpierced and pierced by a piercing member of a beverage dispenser;

FIGS. 3A and 3B schematically depict different embodiments of a beverage dispenser assembly; and

FIGS. 4A-4D schematically depict different embodiments of expandable cartridges.

### DETAILED DESCRIPTION OF THE FIGURES

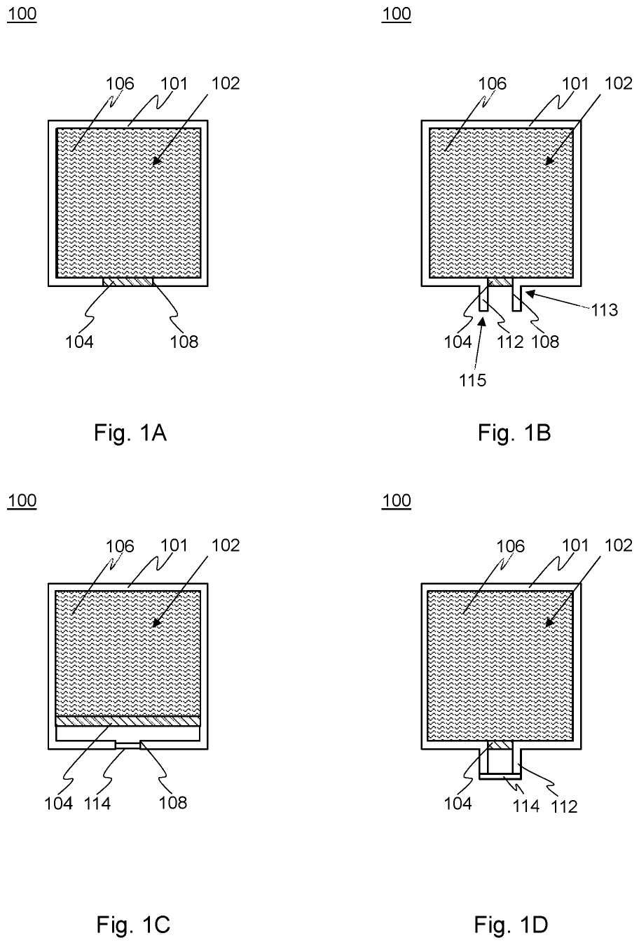

FIGS. 1A-1D show different embodiments of a cartridge 100 for holding a beverage concentrate 106, in a schematic section view. A cartridge may otherwise be known as a capsule, pouch, pod, or container. The beverage concentrate 106 is depicted with a waved pattern in the figures. The cartridges 100 shown in FIGS. 1A-1D all comprise a filter 104 designed for filtering suspended particles from beverage concentrate passing through the filter.

In general, a cartridge 100 comprises a cartridge housing 101 in which an internal volume 102 is present for holding a volume a beverage concentrate. An outer shape of the cartridge housing 101 may be complementary to at least part of a receptacle of a beverage dispenser. The cartridge housing 101 may be a rigid housing or a flexible housing, or the cartridge may be at least partially rigid and at least partially flexible. A flexible cartridge housing part may for example be formed by one or more thin sheets, laminates or films, such that the flexible cartridge housing part resembles a bag or pouch. An outer housing may be provided, surrounding at least part of the cartridge housing 101. As such, for example, a bag-in-container-type cartridge may be obtained.

In the embodiment of the cartridge 100 shown in FIG. 1A, the cartridge housing 101 comprise a passage 108, in which the filter 104 is positioned. Beverage concentrate 106 can flow from the internal volume 102 out of the cartridge housing 101 via the passage 108, thereby passing through the filter 104.

In the embodiment of the cartridge 100 shown in FIG. 1B, the cartridge 100 further comprises an optional spout 112, which spout 112 protrudes away from the internal volume 102. The spout 112 is connected to the cartridge housing 101 at an upstream end 113 of the spout 112. When the beverage concentrate 106 is expelled from the cartridge 100, the beverage concentrate flows through the spout 112 from the upstream end 113 of the spout to the downstream end 115 of the spout 112.

The spout 112 may be a filling gland connected to the cartridge 100 and used to fill the cartridge with beverage concentrate. The spout 112 may for example be glued or welded to the cartridge housing 101. Alternatively, the spout 112 may be integrally formed with the cartridge housing 101.

When the filter is positioned at or near the upstream end of the spout 112, the filter may be protected by the spout 112 from outside influences such as impacts which may damage the filter. Alternatively or additionally, the spout 112 allows for correctly positioning the cartridge 100 in a receptacle of a beverage dispenser. As such, the spout 112 may even be asymmetrical such that the cartridge 100 can only be positioned in the receptacle in one or more distinct orientations relative to the receptacle. Additionally or alternatively, the cartridge housing 101 may be shaped asymmetrically such that the cartridge 100 can only be positioned in the receptacle in one or more distinct orientations relative to the receptacle

In general, the spout 112 may be rigid. Alternatively, at least part of the spout 112 may be flexible, elastic, and/or resilient. This may allow the spout 112 to form a liquid-tight fit with the beverage dispenser, to prevent leakage of beverage concentrate. When at least part of the spout 112 is flexible, elastic, and/or resilient, the spout 112 may be used as a valve, in particular as a one-way valve. Additionally or alternatively, when at least part of the spout 112 is flexible, elastic, and/or resilient, the spout may be clamped or squeezed shut, and may as such act as an essentially liquid-tight seal.

FIG. 1C shows another embodiment of the cartridge 100, wherein the filter 104 is positioned inside the inner volume 102 of the cartridge 100. As a further option, a seal 114 is used to seal off access to the inner volume 102. The seal 114 may be positioned in, behind, or over a passage 108 into the cartridge housing 101. The seal 114 may as such for example prevent contaminants from entering the inner volume 102. In this embodiment, the filter 104 is positioned in between the seal 114 and the beverage concentrate 106. The filter 104 may be positioned at a distance from the seal 114, as shown in FIG. 1C. When the filter 104 is positioned inside the inner volume 102, the filter 104 may be protected, at least to a large extent, by the cartridge housing from outside influences such as contaminants or impacts.

FIG. 1D shows yet another embodiment of the cartridge 100, comprising the optional spout 112. In this embodiment, a seal 114 is provided over an outlet opening of the spout 112. The seal 114 may be removeably connected to the spout 112, such that the seal 114 can be removed by a user and/or a beverage dispenser. The outlet opening of the spout 112 may be a convenient location for the seal 114, to conveniently apply the seal 114 and/or remove the seal 114.

In general, the seal 114 may for example be embodied as a thin sheet. The seal 114 may be substantially impermeable to gasses such as air or oxygen, and/or the seal 114 may be substantially impermeable to liquids, such as the beverage concentrate.

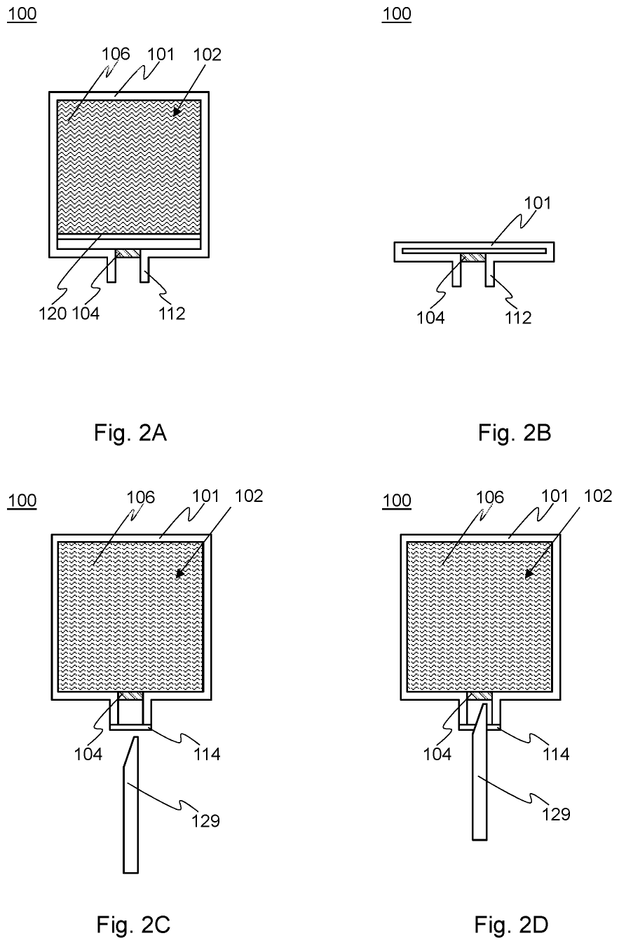

FIG. 2A shows in a schematic section view yet another embodiment of cartridge 100, comprising the cartridge housing 101 and the spout 112. In this particular embodiment, the cartridge 100 comprises a temporary separator 120, which separator 120 prevents contact between the filter 104 and the beverage concentrate 106 inside the internal volume 102. The separator 120 may thus be substantially impermeable to the beverage concentrate.

Long-term contact between the filter 104 and the beverage concentrate 106, for example during transport of storage of the cartridge 100, may be undesirable. For example, the filtering properties of the filter 104 may be negatively affected by the long-term contact between the filter 104 and the beverage concentrate 106. A separator 120 may also allow the use of a filter 104 which is permeable to liquids such as the beverage concentrate, without risk of the liquid leaking through the filter 104 for example during transport or storage of the cartridge 100.

In use, for example by virtue of the expelling actuator of a beverage dispenser, the separator 120 may be broken or removed, such that beverage concentrate 106 can be expelled from the internal volume 102. The expelling actuator of the beverage dispenser is in general arranged to create a pressure difference between an upstream side of the filter 104, where the beverage concentrate 106 is initially present, and a downstream side of the filter 104. This pressure difference causes the beverage concentrate 106 to pass through the filter 104, in particular when the pressure at the upstream side of the filter 104 is higher than the pressure at the downstream side of the filter 104.

FIG. 2B schematically shows in a section view an example of a cartridge 100 from which the beverage concentrate 106 has been expelled. In this example, the cartridge housing 101 has been collapsed, by virtue of which the internal volume 102 has decreased, preferably such that essentially no beverage concentrate remains inside the internal volume 102.

The cartridge housing 101 may be collapsed by virtue of the expelling actuator pressing down onto the cartridge housing 101. Additionally or alternatively, the cartridge housing 101 may be collapsed by virtue of beverage concentrate being sucked out of the internal volume 102 by the expelling actuator of the beverage dispenser.

FIGS. 2C and 2D schematically depict in a section view an embodiment of a cartridge 100 holding a volume of beverage concentrate 106 and comprising a seal 114. The filter 104 is positioned between the beverage concentrate 106 and the seal 114, and the seal 114 is positioned at a distance from the filter 104.

Between the situation depicted in FIG. 2C and 2D, a piercing member 129 has pierced the seal 114 of the cartridge 100. When the seal 114 is pierced, the seal 114 may no longer prevent beverage concentrate 106 from being expelled from the cartridge 100. As can be seen in FIG. 2D, preferably, the piercing member 129 only pierces the seal 114 and does not contact the filter 104 to prevent damaging the filter 104.

In general, any of the embodiments of the cartridge disclosed herein, in particular in conjunction with FIGS. 1A-2D, may be arranged to receive a volume of base liquid inside the internal volume of the cartridge. In such embodiments, the cartridge housing may be an expandable housing, which can be manipulated from an unexpanded state to an expanded state.

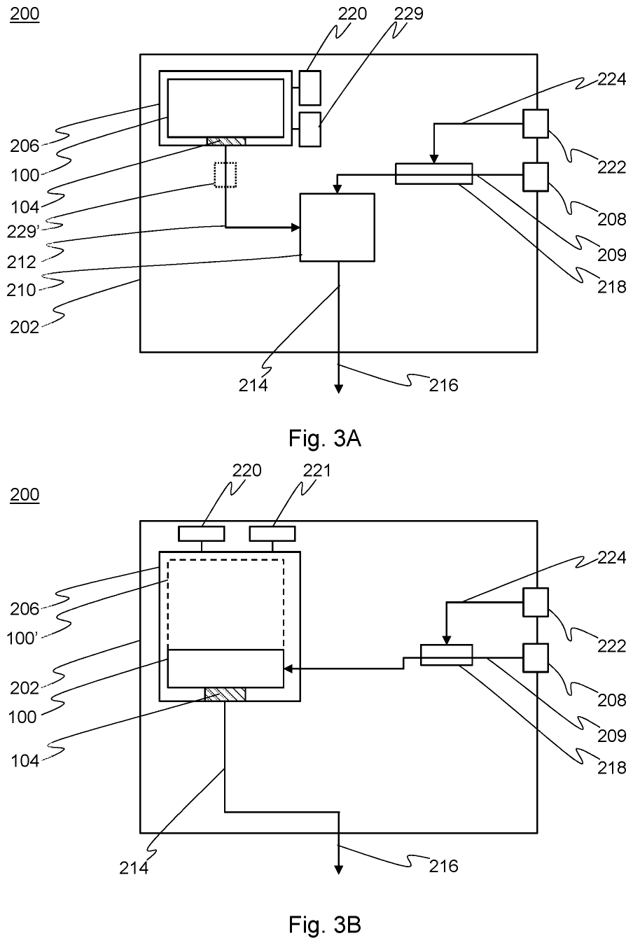

FIGS. 3A and 3B schematically show two embodiments of a beverage dispenser assembly 200, comprising a beverage dispenser 202 and an embodiment of a cartridge 100, which may generally be any cartridge disclosed herein. By virtue of the beverage dispenser assembly 200, a post-mixed beverage may be dispensed from one or more beverage concentrates and one or more base liquids. The beverage dispenser 202 may for example be a table-top dispenser for consumer use.

Reference in now made to the beverage dispenser assembly 200 of FIG. 3A. In this embodiment of the assembly 200, the beverage dispenser 202 comprises a receptacle 206 with a reception volume in which a cartridge 100 is positioned. The cartridge 100 holds a volume of beverage concentrate. The beverage dispenser 202 further comprises a base liquid input 208 for receiving a base liquid. The base liquid input 208 may for example be connectable to a base liquid source, such as a faucet supplying tap water or a container comprised by the beverage dispenser.

A carbonator 218 may be comprised by the beverage dispenser 102, to form a carbonated base liquid. The carbonator 218 may for example be positioned in-line with a base liquid conduit 209. To provide a gas such as CO2 to the carbonator 218, the beverage dispenser 202 comprises a gas inlet 222 and a gas conduit 224 for transporting gas from the gas inlet 222 to the carbonator 218.

As a particular option depicted in FIG. 3A, the beverage dispenser 202 comprises a mixing chamber 210, which is in fluid communication with the base liquid input 208 via a base liquid conduit 209 and is also in fluid communication with the cartridge 100 via a beverage concentrate conduit 212. The mixing chamber 210 can thus receive base liquid and beverage concentrate, and inside the mixing chamber 210, the base liquid and beverage concentrate may mix to form the post-mixed beverage. From the mixing chamber 210, via a post-mixed beverage conduit 214, the post-mixed beverage may be dispensed via a dispensing outlet 216.

As depicted in FIG. 3A, the cartridge 100 may comprise a filter 104 designed for filtering suspended particles from a beverage concentrate passing through said filter. The filtered particles are as such prevented from travelling downstream towards the mixing chamber 210.

It will be understood that instead of the filter 104 comprised by the cartridge 100, or additional thereto, a filter may be comprised by the beverage dispenser 202 designed for filtering particles from a flow of liquid, such as a beverage concentrate, base liquid, or post-mixed beverage, passing through said filter. For filtering particles from the beverage concentrate, the filter may for example be positioned in the beverage concentrate conduit 212.

For expelling the beverage concentrate from the cartridge 100, the beverage dispenser 202 comprises an expelling actuator 220. The expelling actuator 220 may for example be arranged to be moved towards the cartridge 100, and in particular squeeze, collapse, and/or crush the cartridge 100 into the emptied state. Alternatively, or additionally, the expelling actuator 220 may be arranged to suck post-mixed beverage from the cartridge 100, which may cause the cartridge 100 to become collapsed into the emptied state, for example using the Venturi effect.

FIG. 3B schematically shows another embodiment of the beverage dispenser assembly 200. In this embodiment, the cartridge 100 holding the beverage concentrate is an expandable cartridge. Using an expandable cartridge may eliminate the need for a separate mixing chamber. In FIG. 3B, the cartridge 100 is shown in an unexpanded state with a solid line, and in an expanded state with the dashed line 100′.

Any of the embodiments of the beverage dispenser 202 may comprise the piercing member 129 arranged to pierce an optional seal of the cartridge without piercing the filter. The piercing member 129 may be positioned to moved further into the reception volume 206 in order to pierce the seal of a cartridge positioned in said reception volume 206.

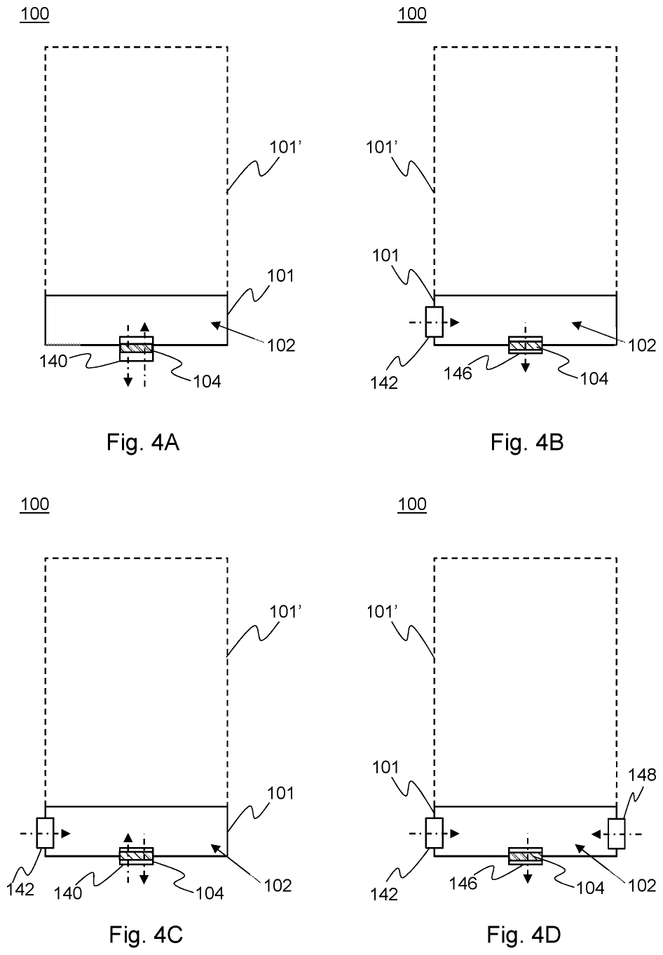

Instead of the separate mixing chamber 210, in the embodiment of FIG. 3B, the expandable cartridge 100 is used as a mixing chamber in which the post-mixed beverage is formed by mixing beverage concentrate and base liquid. To this end, the base liquid input 208 is in fluid communication with the receptacle 206 in which the expandable cartridge 100 is positioned to supply base liquid to the expandable cartridge 100, for example to a fluid passage of the expandable cartridge 100 as will be elucidated in conjunction with FIGS. 4A-4D.

A post-mixed beverage conduit 214 is positioned in fluid communication with the receptacle 206, to receive post-mixed beverage from the expandable cartridge 100. Via the post-mixed beverage conduit 214, the post-mixed beverage can be dispensed through the dispensing outlet 216 at a downstream end of the post-mixed beverage conduit 214. The post-mixed beverage conduit 214 may be comprised by the beverage dispenser 202, or by the cartridge 100. The post-mixed beverage conduit 214 may at least partially be a flexible conduit, in particular when comprised by the cartridge 100 to allow a user to correctly position the post-mixed beverage conduit 214 relative to the beverage dispenser 202. Alternatively, the post-mixed beverage conduit 214 may be a rigid conduit, for example a rigid outlet spout comprised by the cartridge 100.

As an option schematically shown in FIG. 3B, the beverage dispenser 202 may comprise an optional agitation unit 221. The agitation unit 221 is generally arranged for agitating a liquid inside the expandable cartridge.

In the assembly 200 of FIG. 3B, the cartridge 100 comprises an expandable housing. As an option, the expandable housing comprises a foldable housing part. The foldable housing part may be folded out and away from an internal volume of the cartridge when the expandable housing is manipulated from the unexpanded state to the expanded state.

In general, foldable collapsible housing part of the expandable housing may be formed as a bellow, arranged to be expanded to accommodate a larger volume of fluid in the internal volume. The larger volume may for example be caused by base liquid being pumped or sucked into the internal volume, and/or by beverage concentrate being pumped or sucked into the internal volume. A bellow may comprise a plurality of pleats arranged to fold relative to each other.

As a further option, at least part of the expandable housing comprises a stretchable material, arranged to stretch by virtue of a pressure difference between a pressure inside the internal volume and the pressure outside the expandable housing. For example, when a pressure inside the internal volume exceeds a pressure outside the expandable housing, the stretchable material stretches out and as such, the internal volume increases. The pressure inside the internal volume may for example be increased by virtue of a pump pumping base liquid into the internal volume.

An expandable housing comprising a stretchable material may function similar to a balloon, which when inflated accommodates a larger volume of fluid compared to a deflated state. When a pressure inside the internal volume equals a pressure outside the housing, and no external forces are applied to the housing, the stretchable part of the housing may be in a resting state-e.g. not elastically deformed.

Elaborating further on the option that envisioned embodiments of cartridges may be expandable cartridges, FIG. 4A-4D schematically show different embodiments of an expandable cartridge 100, wherein the cartridge housing 101 in unexpanded state is depicted with a solid line, and in the expanded state is indicated with a dashed line 101′, which can partially overlap the solid line.

In general, for an expandable cartridge, it may be required that the internal volume can be first filled with a volume of beverage concentrate, for example at a filling plant. Next, the internal volume is further filled with a volume of base liquid, for example by a beverage dispenser at a consumer's home or at a commercial location such as a bar. As such, a post-mixed beverage is formed in the internal volume, which post-mixed beverage comprises the base liquid and the beverage concentrate. Finally, the internal volume has to be at least partially emptied, by expelling the post-mixed beverage from the internal volume. It is hence understood that the expandable cartridge may comprise one or more fluid inlets and one or more fluid outlets, wherein in particular embodiments a fluid inlet may also be used as a fluid outlet.

In the embodiment of FIG. 4A, the cartridge 100 comprises a single fluid passage 140 into the internal volume 102. The single fluid passage 140 is used as a fluid inlet for allowing the internal volume 102 to be filled with the volume of beverage concentrate and the volume of base liquid. The single fluid passage 140 is also used as a fluid outlet, for allowing post-mixed beverage to flow out of the internal volume 102. In the figures, the possible directions of fluid passing through the passages is generally indicated by dash-dotted arrows. A filter 104 for designed for filtering suspended particles from post-mixed beverage passing from the internal volume through the filter can be positioned in, on, or over the fluid passage 140.

In the embodiment of FIG. 4B, the cartridge 100 comprises a fluid inlet 142 allowing the internal volume 102 to be filled with the volume of beverage concentrate and the volume of base liquid. The cartridge 100 further comprises a fluid outlet 146 allowing post-mixed beverage to flow out of the internal volume 102. When a fluid passage is used only as a fluid inlet or only as a fluid outlet, in particular a one-way valve may be present in the fluid passage which restricts passage of fluid in one direction, while allowing passage of the fluid in the opposite direction. A particular pressure differential over the one-way valve may be required for opening the one-way valve. The one-way valve may for example be an umbrella valve or duckbill valve.

In the embodiment of FIG. 4B, a filter 104 designed for filtering suspended particles from post-mixed beverage passing from the internal volume through the filter can be positioned in, on, or over the fluid outlet 146—such that post-mixed beverage passes through said filter 104 when expelled from the cartridge 100.

In the embodiment of FIG. 4C, the cartridge 100 comprises a fluid inlet 142 allowing the internal volume 102 to be filled with a first of the volume of beverage concentrate and the volume of base liquid. The cartridge 100 further comprises the fluid passage 140, which is used to allow the internal volume 102 to be filled with the second of the volume of beverage concentrate and the volume of base liquid. The fluid passage 140 is also used as a fluid outlet, for allowing post-mixed beverage to flow out of the internal volume 102.

As such, the fluid inlet 142 may be a dedicated fluid inlet for filling the internal volume either with the beverage concentrate, or with the base liquid. As such, the fluid inlet 142 may be designed to be compatible with a filling machine at the filling plant or with the beverage dispenser for dispensing the post-mixed beverage. When the fluid inlet 142 is designed to be compatible with the filling machine at the filling plant, the fluid passage 140 may be designed to be compatible with the beverage dispenser.

In the embodiment of FIG. 4C, a filter 104 designed for filtering suspended particles from post-mixed beverage passing from the internal volume through the filter can be positioned in, on, or over the fluid outlet 140—such that post-mixed beverage passes through said filter 104 when expelled from the cartridge 100.

In the embodiment of FIG. 4D, the cartridge 100 comprises a beverage concentrate inlet 142 for receiving the volume of beverage concentrate into the internal volume 102. The cartridge 100 further comprises a base liquid inlet 148 separate from the beverage concentrate inlet 142, for receiving the volume of base liquid into the internal volume 102. The cartridge 100 also comprises a separate fluid outlet 146, for allowing post-mixed beverage to flow out of the internal volume 102.

In the embodiment of FIG. 4C, a filter 104 designed for filtering suspended particles from post-mixed beverage passing from the internal volume through the filter can be positioned in, on, or over the fluid outlet 146—such that post-mixed beverage passes through said filter 104 when expelled from the cartridge 100.

In general, when the cartridge 100 comprises a substantially rigid, non-expandable housing part, the one or more fluid inlets and/or the one or more fluid outlets may be provided by or through the non-expandable housing part. As such, when the cartridge 100 is manipulated from the unexpanded state to the expanded state, the position and/or orientation of the one or more fluid inlets and/or the one or more fluid outlets may remain unchanged relative to the receptacle of the beverage dispenser. Alternatively, the one or more fluid inlets and/or the one or more fluid outlets may be provided by or through an expandable housing part. For example, a fluid inlet with which the cartridge is filled with beverage concentrate may be provided by or through an expandable housing part.

In general, when the cartridge 100 is an expandable cartridge, in the unexpanded state, the internal volume 102 may be between 30 mL and 150 mL, or may even be larger than 150 mL, even larger than 500 mL or larger than 1000 mL, and is filled with beverage concentrate. In the expanded state, the internal volume 102 may be between 250 mL and 500 mL, or even between 500 mL and 2500 mL, or even larger than 2500 mL or even larger than 5000 mL, and is filled with beverage concentrate and base liquid. In the emptied state, the internal volume 102 may be less than 30 mL, less than 10 mL, or even approximately 0 mL, such that no or essentially no beverage is left behind in the cartridge 100. The ratio between the internal volume 102 in the unexpanded state and the internal volume 102 in the expanded state may depend on a desired mixing ratio between the beverage concentrate and the base liquid. The volumes disclosed in this paragraph may be generally applied to any other embodiment of the cartridge 100 disclosed herein.

Now referring again to the beverage dispenser assembly 200, as for example depicted in FIGS. 3A, as a particular option, embodiments of the beverage dispenser 202 may comprise a cooling unit 229 for withdrawing thermal energy from the reception volume 206 and/or for withdrawing thermal energy from the beverage concentrate conduit 212 comprised by the beverage dispenser. As such, beverage concentrate may be cooled prior to being mixed with the one or more base liquids.

It will be understood that in general, it may be an object to dispense a cold post-mixed beverage. A cold post-mixed beverage may have any temperature which in particular is below ambient temperature. A cold post-mixed beverage may have a temperature below 10 degrees C., below 8 degrees C., below 6 degrees C., or even below 4 degrees C., below 2 degrees, or even approximately 0 degrees C. For some post-mixed beverages, the dispensing temperature may even be below 0 degrees C., in particular when the post-mixed beverage has a high sugar and/or alcohol content. Any cartridge disclosed herein may thus be a cartridge arranged for use in a beverage dispenser for dispensing a cold post-mixed beverage from a beverage concentrate and a base liquid

By cooling the beverage concentrate using the cooling unit of the beverage dispenser, the temperature of the beverage concentrate can be controlled. By being able to control the temperature of the beverage concentrate, the temperature of the dispensed post-mixed beverage can be controlled better, in particular when the temperature of the base liquid or base liquids can be controlled as well by the beverage dispenser. In particular, the temperature of the dispensed post-mixed beverage may become less dependent or even independent of the temperature of the cartridge when received by the beverage dispenser.

The cooling unit of the beverage dispenser generally refers to any component of the beverage dispenser contributing to the process of cooling the beverage concentrate. For example, the cooling unit may comprise a thermoelectric cooler for cooling based on the Peltier effect. As another example, the cooling unit is arranged to cool based on vapour compression refrigeration. As such, the cooling unit may comprise one or more of a compressor, evaporator, condenser and expansion valve. A cooling fluid such as a cooling liquid such as water or glycol or a cooling gas such as CO2 may be used in the vapour compression refrigeration cycle.

Alternatively, the cooling unit is arranged to receive a cooled medium such as a cooled fluid, liquid, and/or gas cooled by an external cooling unit not comprised by the beverage dispenser. The cooled medium may be used by the cooling unit to withdraw thermal energy from the beverage concentrate.

The cooling unit may comprise one or more heat exchangers for withdrawing thermal energy from the beverage concentrate. The cooling fluid may be circulated through the cooling unit and through the one or more heat exchangers. A heat exchanger may for example be a tube-in-tube heat exchanger.

In addition to or alternatively to being cooled while inside the cartridge, the beverage concentrate may be cooled after being expelled from the cartridge, but prior to the mixing of the beverage concentrate with the base liquid. For example, the expelled beverage concentrate may flow through a conduit from which thermal energy can be withdrawn using the cooling unit. Such a cooling unit is indicated with a dotted square 229′ in FIG. 3A. In general, a cooling unit may also be comprised by the beverage dispenser 202 shown in FIG. 3B.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

Amendment to the claims:

1. A cartridge for holding a beverage concentrate, which cartridge is arranged for use in a beverage dispenser for dispensing a post-mixed beverage from a beverage concentrate and a base liquid, the cartridge comprising:
an internal volume for holding the beverage concentrate; and
a filter, wherein the filter is designed for filtering particles from a flow of liquid, such as a beverage concentrate, passing from the internal volume through the filter.

2. The cartridge according to claim 1, wherein the internal volume is filled with a beverage concentrate, which beverage concentrate is based on a fermented beverage.

3. The cartridge according to claim 2, wherein the beverage concentrate comprises liquid with particles mixed, settled, suspended or dispersed therein, which particles comprise one or more proteins, sugars, organic compounds, polyphenols, hop acids, and/or oxalates.

4. The cartridge according to claims claim 2, wherein the filter is designed for filtering particles from the beverage concentrate.

5. The cartridge according to claim 1, wherein the filter is designed for filtering suspended particles with a particle size larger than 0.2 μm.

6. The cartridge according to claim 5, wherein the filter is designed for filtering suspended particles with a particle size between 0.2-100 μm.

7. The cartridge according to claim 2, further comprising a temporary separator, which separator prevents contact between the filter and the beverage concentrate inside the internal volume.

8. The cartridge according to claim 1, further comprising a spout (112) protruding away from the internal volume.

9. The cartridge according to claim 1, wherein the cartridge housing is an expandable housing, arranged to be further filled with a base liquid, such that a post-mixed beverage can be formed inside the internal volume from the beverage concentrate and the base liquid.

10. A beverage dispenser assembly for dispensing a post-mixed beverage from a beverage concentrate and a base liquid, the assembly comprising a beverage dispenser and a cartridge according to claim 1, wherein the beverage dispenser comprises:
a dispenser housing with a receptacle for receiving at least part of the cartridge;
a base liquid input for receiving a base liquid;
a beverage concentrate input which is in fluid communication with the receptacle;
a post-mixed beverage conduit which is in fluid communication with the base liquid input and the beverage concentrate input, and has a post-mixed beverage output at a downstream end; and
an expelling actuator for expelling beverage concentrate from internal volume of the cartridge, through the filter of the cartridge.

11. The beverage dispenser assembly according to claim 10, wherein the cartridge comprises a seal positioned at a distance from the filter, and the beverage dispenser further comprises a piercing member arranged to pierce the seal of the cartridge without piercing the filter.

12. A method of dispensing a post-mixed beverage from a beverage concentrate and a base liquid, comprising the steps of:
providing or receiving a cartridge with an internal volume holding a beverage concentrate;
providing or receiving a base liquid;
expelling the beverage concentrate from the cartridge;
allowing the beverage concentrate and the base liquid to mix and form the post-mixed beverage; and
dispensing the post-mixed beverage;
wherein the beverage concentrate passes through a filter prior to the dispensing of the post-mixed beverage.

13. The method according to claim 12, wherein the filter is comprised by the cartridge.

14. The method according to claim 12, wherein the beverage concentrate passes through the filter prior to the forming of the post-mixed beverage.

15. The method according to claim 12, further comprising discarding the cartridge with particles trapped in the filter after the post-mixed beverage is dispensed.

16. The cartridge according to claim 1, wherein the beverage concentrate is based on a beer.

17. The cartridge according to claim 1, further comprising a seal, and wherein the filter is positioned between the seal and the internal volume of the cartridge.

18. The cartridge according to claim 17, wherein the seal is positioned at a distance from the filter.

19. The method according to claim 12, wherein the beverage concentrate passes through the filter after having been mixed into the post-mixed beverage.

20. The method according to claim 12, wherein the cartridge is arranged for use in a beverage dispenser for dispensing a post-mixed beverage from a beverage concentrate and a base liquid, the cartridge comprising the filter, wherein the filter is designed for filtering particles from a flow of liquid passing from the internal volume through the filter.
